(19) United States
(12) Patent Application Publication
(10) Pub. No.: US 2005/0030428 A1
(43) Pub. Date: Feb. 10, 2005

(54) On-screen display device

(76) Inventors: Satoru Kotani, Osaka (JP); Toshihiko Maruoka, Osaka (JP); Keisuke Tanaka, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/909,365

(22) Filed: Aug. 3, 2004

(30) Foreign Application Priority Data
Aug. 5, 2003 (JP) 2003-287129

(51) Int. Cl. H04N 5/50

(52) U.S. Cl. 348/569

(57) ABSTRACT

The present invention provides an on-screen display device that can effectively utilize a part of a video RAM area for characters which perform special character display. This on-screen display device includes a register that retains information for performing special character display of respective lines, such as through display or space display, and compares display information of the respective line between the register and a display line counter, to output information indicating whether the special character display is to be performed or not to the video RAM, thereby effectively utilizing a part for performing the special character display in the video RAM area.

### FIELD OF THE INVENTION

The present invention relates to on-screen display devices which display desired characters.

### BACKGROUND OF THE INVENTION

Televisions or videocassette recorders utilize an on-screen function of displaying information that indicates states of the device such as channels or programming of recording, on the television screen.

Initially, a conventional on-screen display device will be described with reference to FIGS. 7. FIG. 7(a) is a diagram illustrating a structure of the conventional on-screen display device.

A display character setting unit 100 writes desired character data at a predetermined position in a video RAM 200.

The video RAM 200 has addresses corresponding to positions on the display for displaying a character. FIG. 7(b) shows an address map of the conventional video RAM 200. On the screen of the display, it is possible to display 12 lines of 24 characters. Character data that can be controlled for each line (line attribute code) is composed of 24 bits. In addition, character data that can be controlled for each character is composed of 8 bits. The character data comprises a character code indicating the type of a character to be displayed (hereinafter, referred to as a display character), or an attribute code indicating an instruction of modification for each character (modification information such as the color of the display character or the background of the character) and an character code indicating the type of the character.

A display control unit 300 reads character data from the video RAM 200 before starting to display a characters at a desired position, reads font data corresponding to a character code included in the readout character data, from a character generator ROM 400, and generates an on-screen output signal using the readout font data and an attribute code that is read from the video RAM 200.

In the character generator ROM 400, plural kinds of font data are stored.

The operation of the on-screen display device that is constructed as described above will be described.

First, the display character setting unit 100 writes character data corresponding to one screen, which comprise character codes and attribute codes of the characters to be displayed, at addresses in the video RAM 200 corresponding to positions on the display at which the characters are displayed, as indicated by the video RAM address map of FIG. 7(b).

Then, the display control unit 300 reads the character data that have been written in the video RAM 200 at predetermined timing, and reads font data that are stored in the character generator ROM 400 at addresses indicated by the character codes that are included in the character data. Then, the display control unit 300 outputs an on-screen output signal on the basis of the font data read from the character generator ROM 400 and character modification information that is indicated by the attribute code included in the character data that are read from the video RAM 200.

Accordingly, it is possible to display, on the display, characters which have been subjected to desired character modification. In order to increase the kinds of character modifications (coloring of the display character itself, the color of the background of the character, and the like), details of the character modifications are previously stored in the video RAM 200 (See Japanese Published Patent Application No. Hei. 09-54575).

In the conventional structure, however, a video RAM area must be provided to store the character data also in cases of performing display of special characters such as through display or space display, and accordingly it is impossible to effectively utilize the video RAM area (See Japanese Published Patent Application No. Hei. 09-54575).

### SUMMARY OF THE INVENTION

The present invention provides an on-screen display device that can effectively utilize the video RAM area in performing special character display.

Other objects and advantages of the invention will become apparent from the detailed description that follows. The detailed description and specific embodiments described are provided only for illustration since various additions and modifications within the spirit and scope of the invention will be apparent to those of skill in the art from the detailed description.

According to a 1st aspect of the present invention, there is provided an on-screen display device for displaying desired characters on a display, in which data of a character is composed of a character code which indicates the type of the character, or an attribute code which indicates a modification instruction for each character and a character code which indicates the type of the character, and this on-screen display device includes: a video RAM that retains the character data of the desired characters which are to be displayed on the display; a display character setting unit that writes the character data at a predetermined position in the video RAM; a character generator ROM that outputs font data corresponding to the character code that is included in the character data outputted from the video RAM; a register that sets for each line whether a display line is a line displaying only special characters or not; and a display controller that, when the register sets the display line as a line displaying only special characters, generates an on-screen output signal of the display line corresponding to the special character, while when the register sets the display line is not a line displaying only special characters, reads character data of the display line from the video RAM, reads font data corresponding to the character code that is included in the readout character data, from the character generator ROM, and generates an on-screen display signal of the display line based on the readout font data and the attribute code included in the character data. Therefore, a character data area and a line attribute area for a line displaying only special characters in the video RAM area can be made empty, and this empty area can be used for other purposes, thereby effectively utilizing the video RAM area. Further, since the special character information is stored in the register, this on-screen display device is especially useful in cases where a specific line is set to always display only special characters.

According to a 2nd aspect of the present invention, there is provided an on-screen display device for displaying desired characters on a display, in which data of a character is composed of a character code which indicates the type of the character, or an attribute code which indicates a modification instruction for each character and a character code which indicates the type of the character, and the attribute code includes a per-line special character code which indicates whether a display line is a line displaying only special characters or not, and this on-screen display device includes: a video RAM that retains the character data of the desired characters which are to be displayed on the display; a display character setting unit that writes the character data at a predetermined position in the video RAM; a character generator ROM that outputs font data corresponding to the character code that is included in the character data outputted from the video RAM; and a display controller that reads the attribute code of a display line from the video RAM at a start of displaying of the display line, then detects the per-line special character code that is included in the readout attribute code, and when the per-line special character code indicates that the display line is a line displaying only special characters, generates an on-screen output signal of the display line corresponding to the special character, while when the per-line special character code indicates that the display line is not a line displaying only special characters, reads character data of the display line from the video RAM, reads font data corresponding to the character code that is included in the readout character data from the character generator ROM, and generates an on-screen output signal of the display line on the basis of the readout font data and the attribute code included in the character data. Therefore, the character data area in the video RAM area, which can be controlled for each character on a line displaying only special characters can be made empty, and this empty area can be used for other purposes, thereby effectively utilizing the video RAM area.

According to a 3rd aspect of the present invention, there is provided an on-screen display device for displaying desired characters on a display, in which data of a character is composed of a character code which indicates the type of the character, or an attribute code which indicates a modification instruction for each character and a character code which indicates the type of the character, and the attribute code includes a per-line special character code which indicates whether a display line is a line displaying only special characters or not, and this on-screen display device includes: a video RAM that retains the character data of the desired characters which are to be displayed on the display; a display character setting unit that writes the character data at a predetermined position in the video RAM; a buffer that reads the per-line special character codes of m lines (m is an integer), which are included in the character data, from the video RAM to store the same; a character generator ROM that outputs font data corresponding to the character code that is included in the character data outputted from the video RAM; and a display controller that reads the per-line special character code of the display line from the buffer, and when the per-line special character code indicates that this display line is a line displaying only special characters, generates an on-screen output signal of the display line corresponding to the special characters, while when the per-line special character code indicates that this display line is not a line displaying only special characters, reads character data of the display line from the video RAM, reads font data corresponding to the character code that is included in the readout character data from the character generator ROM, and generates an on-screen output signal of the display line on the basis of the readout font data and the attribute code that is included in the character data. Therefore, the character data area for a line displaying only special characters in the video RAM area can be made empty, and this empty area can be used for other purposes, thereby effectively utilizing the video RAM area. Further, since the line attribute area for the line displaying only the special characters also becomes empty, it is possible to use the line attribute area for other attributes, thereby utilizing the video RAM area more effectively.

According to a 4th aspect of the present invention, there is provided an on-screen display device for displaying desired characters on a display, in which data of a character is composed of a character code which indicates the type of the character, or an attribute code which indicates a modification instruction for each character and a character code which indicates the type of the character, and the attribute code includes a per-character special character code which indicates whether a display character is a special character or not, and this on-screen display device includes: a video RAM that retains the character data of the desired characters which are to be displayed on the display; a display character setting unit that writes the character data at a predetermined position in the video RAM; a buffer that reads the per-character special character codes of n characters (n is an integer), which are included in the character data, from the video RAM to store the same; a character generator ROM that outputs font data corresponding to a character code that is included in the character data outputted from the video RAM; and a display controller that reads the per-character special character code of the display character from the buffer, and when the per-character special character code indicates that this display character is a special character, generates an on-screen output signal of the display character corresponding to the special character, while when the per-character special character code indicates that the display character is not a special character, reads character data of the display character from the video RAM, reads font data corresponding to the character code that is included in the readout character data from the character generator ROM, and generates an on-screen output signal of the display character on the basis of the readout font data and the attribute code that is included in the character data. Therefore, the character data area for characters displaying only special characters in the video RAM area can be made empty, and this empty area can be used for other purposes, thereby effectively utilizing the video RAM area.

### BRIEF DESCRIPTION OF THE DRAWINGS

FIG. 1(a) is a diagram illustrating a structure of an on-screen display device according to a first embodiment of the present invention.

FIG. 1(b) is a diagram illustrating an address map of a video RAM in the on-screen display device according to the first embodiment.

FIG. 1(c) is a diagram showing data of special character information that is stored in a register of the on-screen display device according to the first embodiment.

FIG. 2 is a diagram illustrating an output in a case of performing an on-screen display, using the on-screen display device according to any of the first to third embodiments of the present invention and data in the video RAM.

FIG. 3 is an address map of a video RAM in an on-screen display device according to a second embodiment of the present invention.

FIG. 4(a) is a diagram illustrating a structure of an on-screen display device according to a third embodiment of the present invention.

FIG. 4(b) is an address map of a video RAM in the on-screen display device according to the third embodiment.

FIG. 5 is an address map of a video RAM in an on-screen display device according to a fourth embodiment of the present invention.

FIG. 6 is a block diagram illustrating an example where a RAM and a ROM of a CPU are respectively employed also as the video RAM and the character generator ROM according to any of the first to fourth embodiments.

FIG. 7(a) is a diagram illustrating a structure of a conventional on-screen display device.

FIG. 7(b) is a diagram illustrating an address map of a video RAM in the conventional on-screen display device.

### DETAILED DESCRIPTION OF THE PREFERRED EMBODIMENTS

Hereinafter, embodiments of the present invention will be described with reference to the drawings. The embodiments shown here are exemplary only, and the present invention is not limited to these embodiments.

[Embodiment 1]

An on-screen display device according to a first embodiment of the present invention will be described.

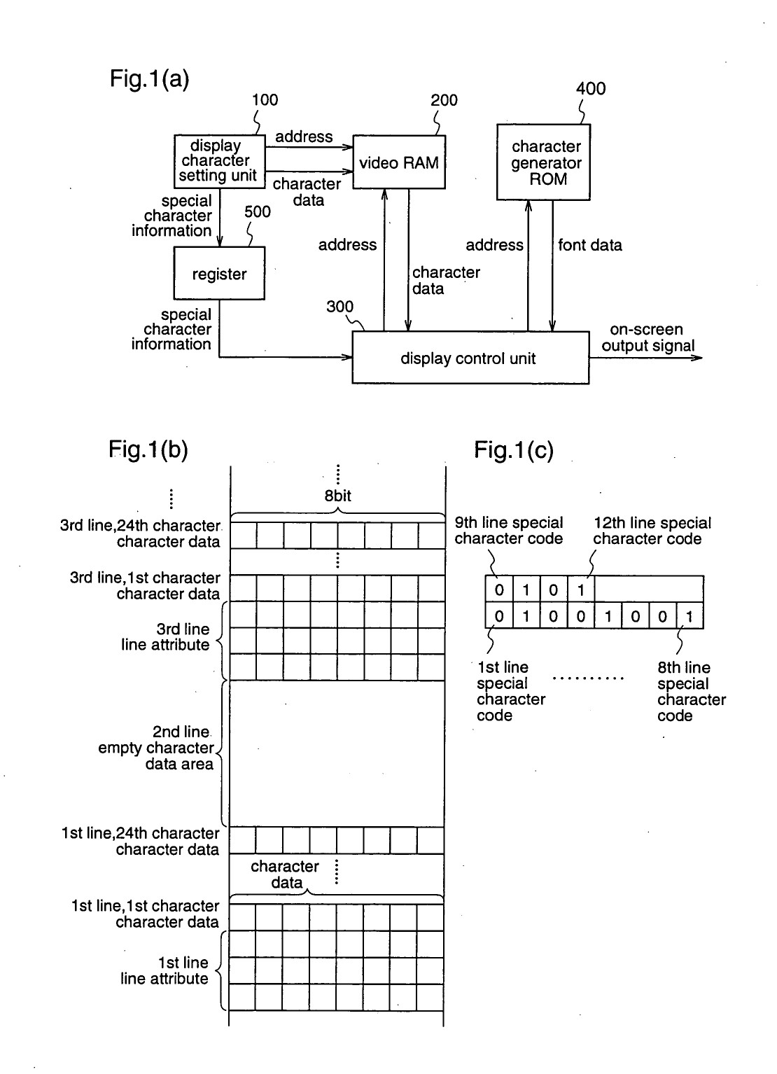

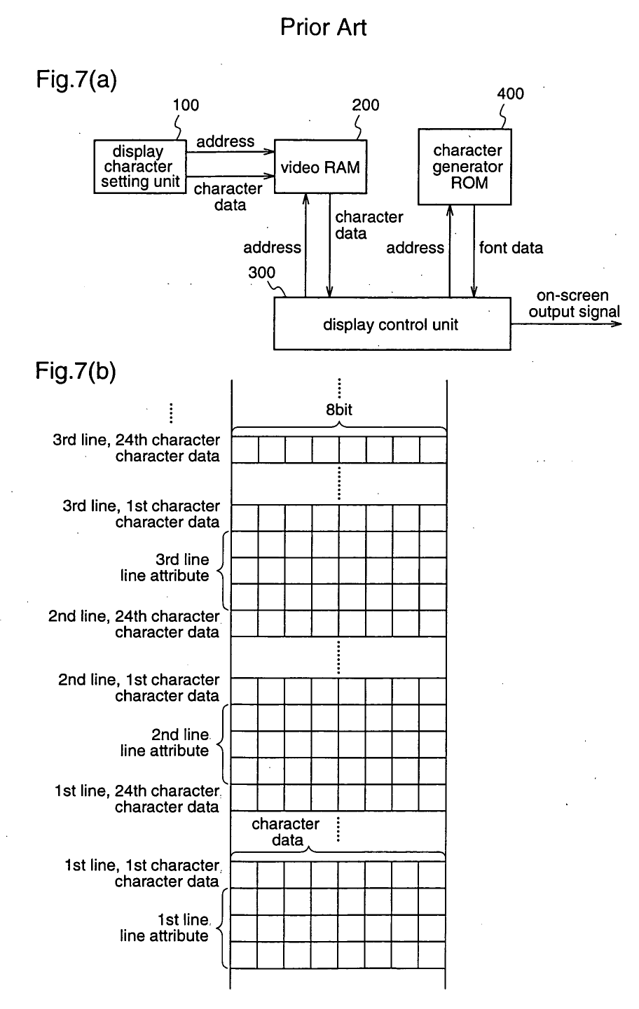

FIG. 1(a) is a diagram illustrating a structure of the on-screen display device according to the first embodiment. In this figure, the same or corresponding components as those in FIG. 7 are denoted by the same reference numerals.

The on-screen display as shown in FIG. 1(a) includes the display character setting unit 100, the video RAM 200, the display control unit 300, and the character generator ROM 400 of the prior art, and further includes a register 500.

The register 500 sets, for each line, whether a display line is a line displaying only special characters such as through display or a space, or not.

In this first embodiment, character data that can be controlled for each line, i.e., a line attribute code, is composed of 24 bits, character data that can be controlled for each character, i.e., character data of one character, is composed of 8 bits and the character data comprises a character attribute code, or a character code and a character attribute code.

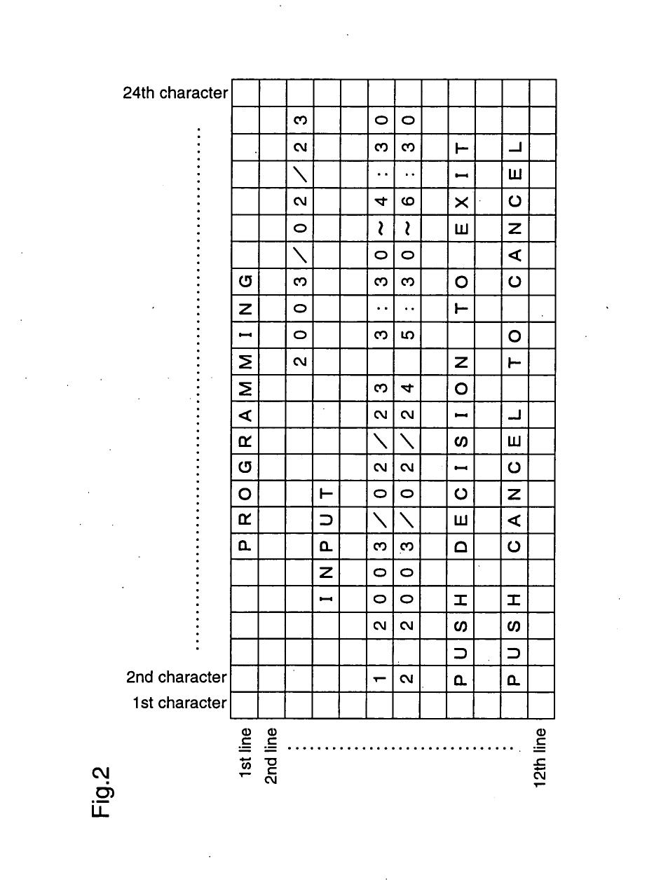

The operation of the on-screen display device that is constructed as described above will be described. It is assumed here that this on-screen display device performs an on-screen display as shown in FIG. 2, and FIG. 1(b) shows an address map of the video RAM 200 in this case.

Initially, the display character setting unit 100 writes data of characters which are to be displayed on the display, i.e., characters corresponding to FIG. 2, at predetermined positions in the video RAM 200. At this time, special character display information as shown in FIG. 1(c) is previously stored in the register 500. Here, the special character display information indicates whether each of 1st to 12th lines is a line displaying only special characters or not. A per-line special character code “0” indicates that this line includes a character other than a space, and a per-line special character code “1” indicates that this line is constituted by only spaces.

The display control unit 300 reads the character data that has been written by the display character setting unit 100, from the video RAM 200 at predetermined timing, and reads font data from the character generator ROM 400, which is stored at an address indicated by the character code that is included in the readout character data. At this time, it is judged whether this display line is a line displaying special characters or not, on the basis of the per-line special character code that is outputted from the register 500, and display line information indicating a line number of the line to be displayed, which is outputted from a display line counter (not shown) for counting the number of lines. When the per-line special character code is “1”, i.e., the display line is a line displaying only special characters, a space line is outputted as an on-screen output signal for this display line. On the other hand, when the per-line special character code is “0”, i.e., the display line is not a line displaying only special characters, an on-screen output signal is generated on the basis of the font data that are read from the character generator ROM 400 and the attribute code included in the character data that are read from the video RAM 200.

The above-mentioned on-screen display device according to the first embodiment stores desired character data in the video RAM 200, stores special character display information indicating whether respective line displays only special characters in the register 500, and generates an on-screen output signal at the start of displaying of the display line on the basis of the special character display information that is read from the register 500. Therefore, character data areas and line attribute areas in the video RAM area for lines displaying only special characters (2nd, 5th, 8th, 10th, and 12th lines in the case of displaying character data as shown in FIG. 2) become empty, and it is possible to employ these empty areas for other purposes, such as for increasing the types of characters, whereby the video RAM area can be effectively utilized. Further, since the special character information is stored in the register 500, it is especially effective in cases where prescribed lines are set to always display only special characters.

[Embodiment 2]

An on-screen display device according to a second embodiment of the present invention will be described. Here, FIG. 7(a) illustrating the structure of the prior art is used as a diagram for showing a structure of the on-screen display device according to the second embodiment.

In this second embodiment, the line attribute code is composed of 24 bits, and character data of one character is composed of 8 bits.

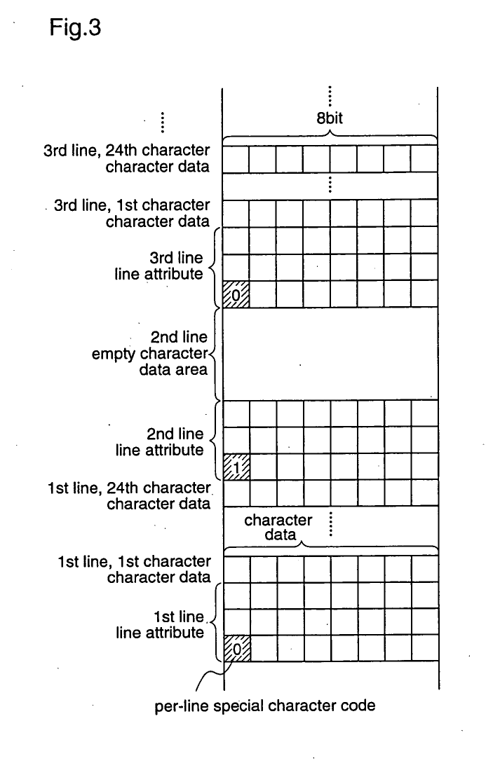

The operation of the on-screen display device that is constructed as described above will be described. It is assumed here that this on-screen display device performs an on-screen display as shown in FIG. 2, and FIG. 3 shows an address map of the video RAM 200 at this time.

Initially, the display character setting unit 100 writes data of characters which are to be displayed on the display, i.e., characters corresponding to FIG. 2, at predetermined positions in the video RAM 200. At this time, as shown in FIG. 3, aper-line special character code indicating whether this display line is a line displaying special characters or not is written in the line attribute part of each line. It is assumed here that a per-line special character code “1” indicates that this line is a line displaying only special characters, and a per-line special character code “0” indicates that this line is not a line displaying only special characters.

The display control unit 300 reads the line attribute of each line, which has been written by the display character setting unit 100, from the video RAM 200, and detects the per-line special character code that has been written in the respective attribute part. When the per-line special character code is “1”, i.e., this display line is a line displaying only special characters, the display control unit 300 outputs a space line as an on-screen output signal of this display line. On the other hand, when the per-line special character code is “0”, i.e., the display line is not a line displaying only special characters, the display control unit 300 reads the character data from the video RAM 200 at predetermined timing, reads font data that is stored in the character generator ROM 400 at an address indicated by the character code included in the readout character data, and generates an on-screen output signal on the basis of the font data and the attribute code included in the character data that are read from the video RAM 200.

The on-screen display device according to the second embodiment writes a per-line special character code indicating whether or not the display line is a line displaying only special characters in the line attribute code that is included in desired character data, stores the same in the video RAM 200, and, at the start of displaying a line to be displayed, generates an on-screen output signal on the basis of the per-line special character code of the display line, which is read from the video RAM 200. Therefore, character data areas which can be controlled for respective characters in the video RAM area, for lines displaying only the special characters (2nd, 5th, 8th, 10th, and 12th lines in the case of displaying the character data as shown in FIG. 2) become empty, and these empty areas can be used for other purposes, whereby it is possible to effectively utilize the video RAM area. Further, since the per-line special character code is written in the line attribute code that is included in the character data to be stored in the video RAM 200, there is no need to provide the register as in the first embodiment, whereby it is possible to realize an on-screen display device having a simple circuit structure and a small circuit scale.

[Embodiment 3]

An on-screen display device according to a third embodiment of the present invention will be described.

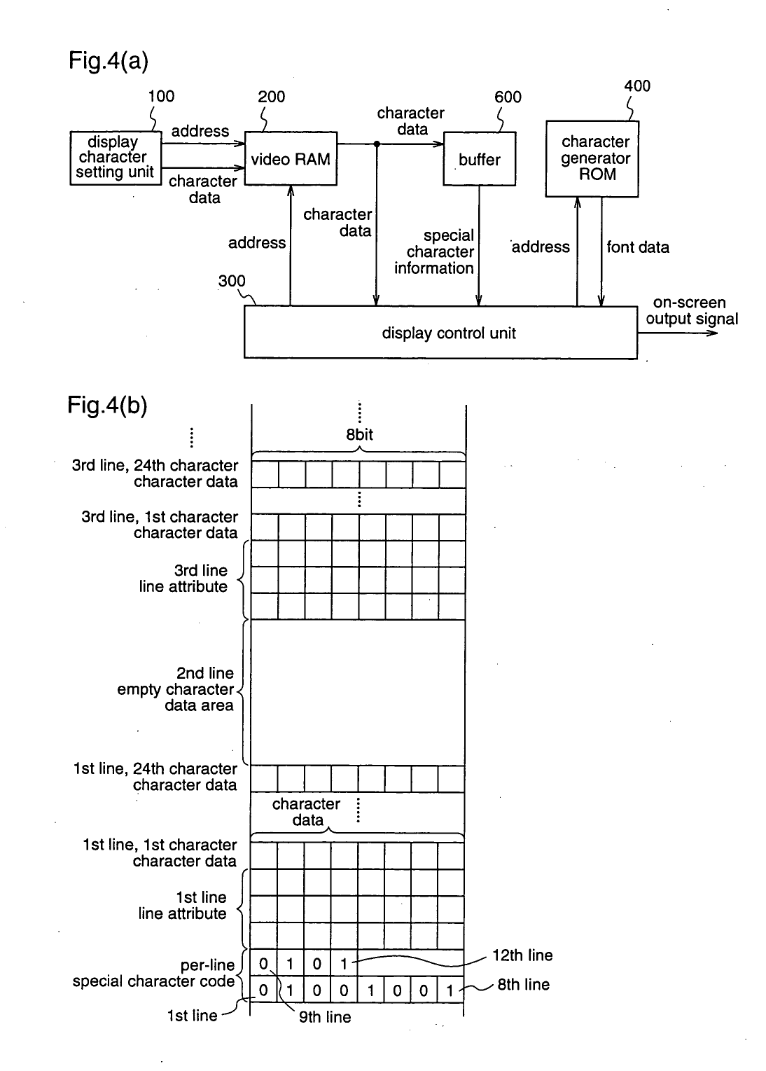

FIG. 4(a) is a diagram illustrating a structure of an on-screen display device according to the third embodiment. In this figure, the same or corresponding components as those in FIG. 7 are denoted by the same reference numerals.

The on-screen display device as shown in FIG. 4(a) includes the display character setting unit 100, the video RAM 200, the display control unit 300 and the character generator ROM 400 of the prior art, and further include a buffer 600.

The buffer 600 reads a per-line special character code that is included in character data of each line, which is displayed on the display, from the video RAM 200 and retains the same.

In this third embodiment, character data of one character is composed of 8 bits, the line attribute code is composed of 24 bits, and the per-line special character code is composed of 12 bits.

The operation of the on-screen display device that is constructed as described above will be described. It is assumed here that the on-screen display device performs an on-screen display as shown in FIG. 2. An address map of the video RAM 200 in this case is shown in FIG. 4(b).

Initially, the display character setting unit 100 writes data of characters that are to be displayed on the display, i.e., characters corresponding to FIG. 2, at predetermined positions in the video RAM 200. At this time, per-line special character codes of respective lines are collectively written as shown in FIG. 4(b). In this case, the per-line special character code “1” indicates that the entire display line is all spaces, and the per-line special character code “0” indicates that the display line includes characters other than the space.

The display control unit 300 reads the per-line special character codes of 12 lines from the video RAM 200, and stores the readout codes in the buffer 600. Then, the display control unit judges whether the display line is a line displaying special characters or not, on the basis of the per-line special character code outputted from the buffer 600. When the per-line special character code is “1”, i.e., when the display line is a line displaying only special characters, a space line is outputted as an on-screen output signal for the display line. On the other hand, when the per-line special character code is “0”, i.e., when the display line is not a line displaying only special characters, the character data that have been written in the video RAM 200 are read at predetermined timing, font data that is stored at an address indicated by the character code that is included in the character data are read from the character generator ROM 400, and an on-screen output signal is generated on the basis of the font data and the attribute code included in the character data that are read from the video RAM 200.

The on-screen display device according to the third embodiment stores desired character data in the video RAM 200, stores per-line special character codes of 12 lines that are to be displayed on one screen in the buffer 600, and when performing a screen display, generates an on-screen output signal on the basis of the per-line special character codes of 12 lines, which are read from the video RAM 200. Therefore, character data areas in the video RAM area for lines displaying only special characters (2nd, 5th, 8th, 10th, and 12th lines in the case of displaying the character data as shown in FIG. 2) become empty, and these empty areas can be used for other purposes, whereby it is possible to effectively utilize the video RAM area. Further, since the line attribute area for the line displaying only the special characters also becomes empty, this empty area can be used for other attributes, whereby it is possible to utilize the video RAM area more effectively. Further, as the per-line special character code is written in the line attribute code that is included in the character data to be stored in the video RAM 200, there is no need to provide the register as in the first embodiment, whereby it is possible to realize the on-screen display device having a simple circuit structure and a small circuit scale.

[Embodiment 4]

An on-screen display device according to a fourth embodiment of the present invention will be described. Here, FIG. 4(a) illustrating the structure according to the third embodiment is employed as a diagram for showing a structure according to the fourth embodiment.

In this fourth embodiment, character data of one character is composed of 8 bits, and a line attribute code is composed of 24 bits.

The operation of the on-screen display device that is constructed as described above will be described.

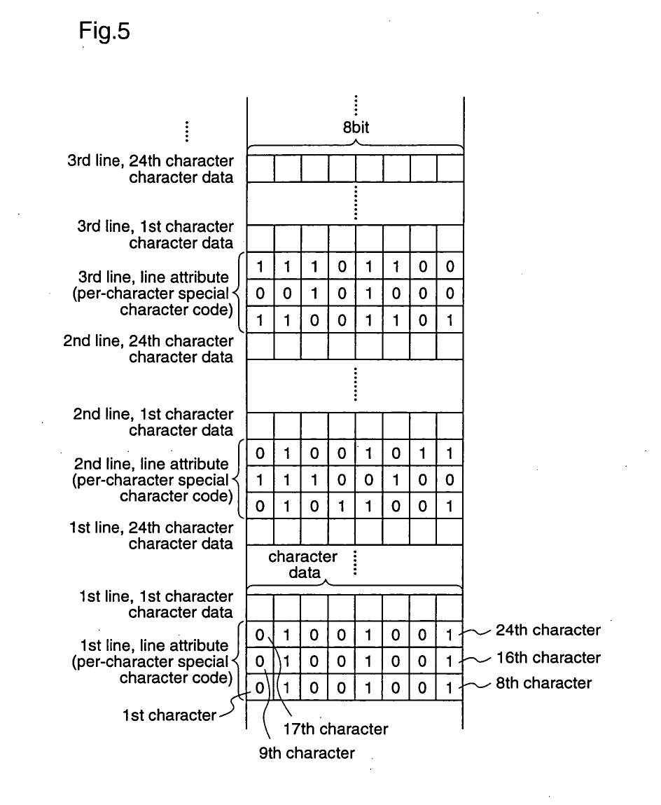

Initially, the display character setting unit 100 writes data of characters which are to be displayed on the display, at predetermined positions in the video RAM 200. At this time, as shown in FIG. 5, per-character special character information that indicates whether respective characters on the screen are for displaying the space or not is written in a line attribute part of respective lines as a per-character special character code.

The display control unit 300 reads the per-character special character code that has been written by the display character setting unit 100 from the video RAM 200 at predetermined timing to store the same in the buffer 600. Then, the display control unit 300 judges whether a display character is a special character (space in this case) or not, on the basis of the per-character special character code that is outputted from the buffer 600. When the per-character special character code indicates a space display, the display control unit 300 outputs a space as an on-screen output signal for the display character. On the other hand, when the per-character special character code does not indicate the space display, i.e., when it indicates display of a character other than the space, the display control unit 300 reads the character data that have been written in the video RAM 200 at predetermined timing, reads font data that is stored at an address indicated by the character code that is included in the character data from the character generator ROM 400, and generates an on-screen output signal on the basis of the font data and the attribute code included in the character data that have been read from the video RAM 200.

The on-screen display device according to the fourth embodiment stores desired character data in the video RAM 200, stores per-character special character codes of all characters that are to be displayed on one screen in the buffer 600, and when performing a screen display, generates an on-screen output signal on the basis of the per-character special character code that is read from the video RAM 200. Therefore, character data areas in the video RAM area for characters displaying only special characters become empty, and these empty areas can be employed for other purposes, whereby it is possible to effectively utilize the video RAM area.

In the first to fourth embodiments, the descriptions have been given of the case where the space is displayed as the special character, while the same effect is achieved also in cases of displaying other special characters such as a through display in which the background is displayed at the time of superimposing.

Further, in the first to fourth embodiments, the descriptions have been given of the case where one kind of special character, i.e., a space is displayed, while when the structure is changed so as to be able to set plural kinds of special characters, for example space display and through display, there can be provided an empty character data area in the video RAM 200 and this empty area can be used for other purposes, whereby it is possible to utilize the video RAM area more effectively.

In the first to fourth embodiments, the codes indicating special character displays are the same over all characters of all lines that are to be displayed on one screen of the display while when different special characters are to be displayed on the respective lines, data that indicate contents of the special character displays for the respective lines are stored in the video RAM 200. In this case, it is also possible to store the data indicating the contents of the special character displays for the respective lines not in the video RAM 200 but in a ROM, and read the data from the ROM before displaying the respective lines. In this way, the video RAM area can be utilized more effectively.

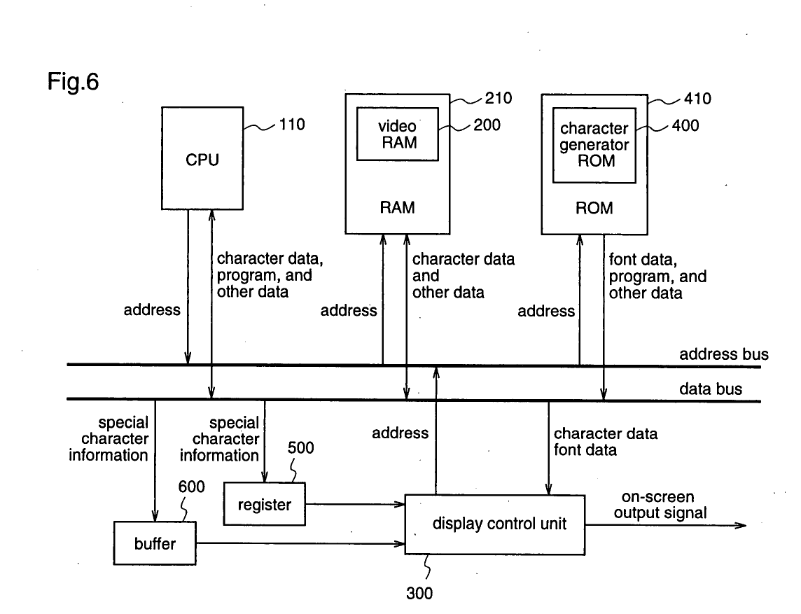

In the first to fourth embodiment, the display character setting unit 100 can be implemented by a CPU (central processing unit). Particularly as shown in FIG. 6, when the display character setting unit 100 is implemented by a CPU 110, the video RAM 200 is included in a RAM 210, the character generator ROM 400 is included in a ROM 410, and the special character information is stored in the register 500 or the buffer 600, it is possible to provide an empty data area of the video RAM 200 in the RAM 210, whereby the software designer can utilize this empty area for other purposes without consciousness.

In the first to fourth embodiment, the number of characters that can be displayed on one screen is 12 lines of 24 characters, while the same effect is achieved with other number of lines or characters.

The on-screen display device according to the present invention is applicable as a character display device, such as a television, which can perform character modification to characters to be displayed, such as coloring of the character itself or the color of the background.

1. An on-screen display device for displaying desired characters on a display, in which
data of a character is composed of a character code which indicates the type of the character, or an attribute code which indicates a modification instruction for each character and a character code which indicates the type of the character,
said on-screen display device including:
a video RAM that retains the character data of the desired characters which are to be displayed on the display;
a display character setting unit that writes the character data at a predetermined position in the video RAM;
a character generator ROM that outputs font data corresponding to the character code that is included in the character data outputted from the video RAM;
a register that sets for each line whether a display line is a line displaying only special characters or not; and
a display controller that, when the register sets the display line as a line displaying only special characters, generates an on-screen output signal of the display line corresponding to the special character, while when the register sets the display line is not a line displaying only special characters, reads character data of the display line from the video RAM, reads font data corresponding to the character code that is included in the readout character data, from the character generator ROM, and generates an on-screen display signal of the display line based on the readout font data and the attribute code included in the character data.

2. An on-screen display device for displaying desired characters on a display, in which
data of a character is composed of a character code which indicates the type of the character, or an attribute code which indicates a modification instruction for each character and a character code which indicates the type of the character, and
said attribute code includes a per-line special character code which indicates whether a display line is a line displaying only special characters or not,
said on-screen display device including:
a video RAM that retains the character data of the desired characters which are to be displayed on the display;
a display character setting unit that writes the character data at a predetermined position in the video RAM;
a character generator ROM that outputs font data corresponding to the character code that is included in the character data outputted from the video RAM; and
a display controller that reads the attribute code of a display line from the video RAM at a start of displaying of the display line, then detects the per-line special character code that is included in the readout attribute code, and when the per-line special character code indicates that the display line is a line displaying only special characters, generates an on-screen output signal of the display line corresponding to the special character, while when the per-line special character code indicates that the display line is not a line displaying only special characters, reads character data of the display line from the video RAM, reads font data corresponding to the character code that is included in the readout character data from the character generator ROM, and generates an on-screen output signal of the display line on the basis of the readout font data and the attribute code included in the character data.

3. An on-screen display device for displaying desired characters on a display, in which
data of a character is composed of a character code which indicates the type of the character, or an attribute code which indicates a modification instruction for each character and a character code which indicates the type of the character, and
said attribute code includes a per-line special character code which indicates whether a display line is a line displaying only special characters or not,
said on-screen display device including:
a video RAM that retains the character data of the desired characters which are to be displayed on the display;
a display character setting unit that writes the character data at a predetermined position in the video RAM;
a buffer that reads the per-line special character codes of m lines (m is an integer), which are included in the character data, from the video RAM to store the same;
a character generator ROM that outputs font data corresponding to the character code that is included in the character data outputted from the video RAM; and
a display controller that reads the per-line special character code of the display line from the buffer, and when the per-line special character code indicates that said display line is a line displaying only special characters, generates an on-screen output signal of the display line corresponding to the special characters, while when the per-line special character code indicates that said display line is not a line displaying only special characters, reads character data of the display line from the video RAM, reads font data corresponding to the character code that is included in the readout character data from the character generator ROM, and generates an on-screen output signal of the display line on the basis of the readout font data and the attribute code that is included in the character data.

4. An on-screen display device for displaying desired characters on a display, in which
data of a character is composed of a character code which indicates the type of the character, or an attribute code which indicates a modification instruction for each character and a character code which indicates the type of the character, and
said attribute code includes a per-character special character code which indicates whether a display character is a special character or not,
said on-screen display device including:
a video RAM that retains the character data of the desired characters which are to be displayed on the display;
a display character setting unit that writes the character data at a predetermined position in the video RAM;
a buffer that reads the per-character special character codes of n characters (n is an integer), which are included in the character data, from the video RAM to store the same;
a character generator ROM that outputs font data corresponding to a character code that is included in the character data outputted from the video RAM; and
a display controller that reads the per-character special character code of the display character from the buffer, and when the per-character special character code indicates that said display character is a special character, generates an on-screen output signal of the display character corresponding to the special character, while when the per-character special character code indicates that the display character is not a special character, reads character data of the display character from the video RAM, reads font data corresponding to the character code that is included in the readout character data from the character generator ROM, and generates an on-screen output signal of the display character on the basis of the readout font data and the attribute code that is included in the character data.
